(19) United States
(12) Patent Application Publication
(10) Pub. No.: US 2026/0187640 A1
(43) Pub. Date: Jul. 2, 2026

(54) THREAT DETECTION AND MANAGEMENT

(71) Applicant: Wells Fargo Bank, N.A., San Francisco, CA (US)

(72) Inventors: Ganesh B. Dadi, Hyderabad (IN); Gridhar Duggirala, Hyderabad (IN); Rameshchandra Bhaskar Ketharaju, Hyderabad (IN); Sathish Parameshwara, Bengaluru (IN); Venkata Praveen Potru, Hyderabad (IN); Suresh Reddy, Hyderabad (IN)

(21) Appl. No.: 19/007,978

(22) Filed: Jan. 2, 2025

(51) Int. Cl. G06Q 20/40

(52) U.S. Cl. CPC G06Q 20/4016

(57) ABSTRACT

Detecting and managing threats that arise from use of electronically-provided financial services. Large language models (LLMs) are trained to classify input data as different types of threats. In some examples, an LLM is trained on synthetic data generated by a generative adversarial network (GAN). Once a threat has been detected and classified, remedial measures can be automatically initiated.

### BACKGROUND

Use of computing systems to provide products and services to customers of institutions present a variety of threats to ensuring that only secure, legal, and regulation-compliant transactions and other actions occur. Such threats can arise from within an institution, such as providing a product or service that violates relevant law or regulations. Such threats can also arise from outside the institution, such as a customer of the institution or a bad actor who performs an illegal transaction or other illegal action using the institution's electronically-provided services.

### SUMMARY

Examples provided herein are directed to detecting and managing threats that arise in connection with electronically-provided financial services.

According to one aspect, the present disclosure relates to a method of managing threats to electronically-provided financial services, the method including: providing initial training data to a discriminator of a generative adversarial network (GAN), the initial training data being generated from a misuse of an electronically-provided financial service; training the discriminator using a generator of the GAN to provide a trained GAN; generating synthetic data using the trained GAN; and training a large language model (LLM) using the synthetic data to provide a trained LLM.

According to another aspect, the present disclosure relates to a system for managing threats to electronically-provided financial services, the system including: an electronic computing device, including: a financial services application installed on the electronic computing device and configured to initiate a transaction; and a threat detection module installed on the electronic computing device and configured as a plug-in to the financial services application, the threat detection module being configured to collect data associated with the transaction to provide collected data; and a server, including: one or more processors; and non-transitory computer-readable storage media encoding instructions which, when executed by the one or more processors, causes the system to: receive transaction data generated by the financial services application; receive the collected data; determine whether the collected data is indicative of a threat to an electronically-provided financial service; when the collected data is not indicative of the threat, allow the transaction to proceed; when the collected data is indicative of the threat: classify the threat using a large language model (LLM) to provide a classified threat; determine a remedial action based on a type of the classified threat; and perform the remedial action to address the threat based on the type.

According to another aspect, the present disclosure relates to a system for managing threats to electronically-provided financial services, the system including: one or more processors; and non-transitory computer-readable storage media encoding instructions which, when executed by the one or more processors, causes the system to: receive initial training data in a discriminator of a generative adversarial network (GAN), the initial training data being generated from a misuse of an electronically-provided financial service and including a screenshot captured by a screen scraper installed on an electronic computing device; training the discriminator using a generator of the GAN to provide a trained GAN; generate synthetic data using the trained GAN; train a large language model (LLM) using the synthetic data to provide a trained LLM; receive transaction data generated by a financial services application installed on another electronic computing device; receive, by the trained LLM, collected data collected by a threat detection module installed as a plug-in to the financial services application; classify, by the trained LLM and based on the collected data, a threat to provide a classified threat; and perform a remedial action to address the classified threat based on a type of the classified threat.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for detecting and managing threats associated with electronically-provided financial services.

FIG. 2 shows an example method that can be performed using the system of FIG. 1.

FIG. 3 shows another example method that can be performed using the system of FIG. 1.

FIG. 4 shows example physical components of one or more devices of the system of FIG. 1.

### DETAILED DESCRIPTION

This disclosure relates to automated threat detection and management of threats that arise in connection with, e.g., from use of, electronically-provided financial services.

Examples of electronically-provided financial services include loan services, fund transfer services, payment services, cash withdrawal services (e.g., provided by an automated teller machine (ATM)), check and cash deposit services (e.g., provided by an ATM), and the like that are performed via electronic devices, such as an ATM, or a computing device that accesses the Internet and/or has stored thereon a financial services software application, such as a banking application issued by a financial institution.

Existing threat intelligence systems do not leverage the potential of large language models (LLMs). LLMs can analyze and understand vast amounts of unstructured text data, which can be crucial for identifying emerging threats. Since existing systems, particularly in the area of electronically-provided financial services, are not equipped to handle this amount and type of data, blind spots in existing threat intelligence systems arise whereby emerging threats are missed, resulting in serious, sometimes catastrophic security breaches and other detrimental consequences.

The present disclosure provides for leveraging of LLM capabilities to enhance detection and classification of threats to electronically-provided financial services, enabling the the detected threats to be addressed before serious or catastrophic consequences can occur, thereby providing a technological solution (using LLMs to detect and classify threats) to a technological problem (how to ensure electronically-provided financial services are secure from both internal and external threats, such as regulatory and policy compliance, as well as bad actors).

From the standpoint of a tiered computing environment via which electronic financial services are provided by a financial institution and used by users (e.g., customers, non-customers who use an ATM of the financial institution, and stakeholders of the financial institution who, e.g., create and build financial services and products), threats associated with the electronically-provided financial services can occur at an operational and infrastructure layer of the overall computing environment as well as at an application or service layer of the of the overall computing environment. Systems and methods herein are configured to detect and manage threats across all layers of a financial institution's computing environment.

Non-limiting examples of types of operational and infrastructure layer threats include a data breach, an insider threat, a system downtime, a hardware malfunction, a physical security system malfunction, a computing device running outdated software, an accessing or sharing of sensitive customer data, skimming of an automated teller machine (ATM), an ATM cash out attack, a malware attack, a ransomware attack, a phishing attach, a social engineering attack, a distributed denial of service (DDoS) attack, non-compliance with a policy or regulation, high resource usage (e.g., at a server level or at a cluster level), and a zero-day exploit.

An example of a data breach is unauthorized access to customer data, such as personal data or financial data.

An example of insider threat is an employee who obtains access to a sensitive system.

An example of non-compliance could be retention or deletion of a document that is against an internal policy of financial institution or against a regulation, or a software patching procedure that is against an internal policy of financial institution or against a regulation.

An example of an ATM cash out attack is manipulation of an ATM switch to approve unauthorized withdrawals.

An example of ATM skimming occurs when a cardholder's payment information is stolen from an ATM, e.g., by installing an unauthorized device such as a skimmer, a camera, or a fake keypad on or near the ATM. The stolen payment information is then used to make fraudulent payments, withdrawals, and the like.

Non-limiting examples of types of application or service layer threats include a vulnerable file (e.g., a Java Archive (JAR)) being used to package an application, a fraudulent transaction, money laundering, a Structured Query Language (SQL) injection, an ATM card withdrawal limit change, a card approval process change, non-compliance with a policy or regulation, greater than a predefined number of instances of failures for an application or an application programming interface (API) of the application within a predefined period of time, greater than a predefined length of time for responses generated by the application, and greater than a predefined number of database query failures within another predefined length of time.

An example of a SQL injection is a cyberattack that permits the attacker access to a database via the insertion of SQL code into an application.

By leveraging LLMs, and other specially configured computing components, such as generative adversarial networks (GANs) and screen scrapers, the present disclosure can provide enhanced detection, classification, and management of one or more or all of the foregoing types of operational/infrastructure threats and application/service threats associated with electronic financial services, as well as other such threats.

A technological problem with employing artificial intelligence (AI) tools to threat detection associated with electronically-provided financial services is how to collect enough non-private data to train the machine learning models properly and adequately. Much of the data from such machine learning models could theoretically learn is private, sensitive data of customers of financial institutions, such as bank account data, transaction data and the like.

The present disclosure provides a technological solution to this technological problem by employing GANs to generate a critical mass of synthetic threat data based on a smaller amount of non-private real threat data. The synthetic threat data is then used to train a LLM to detect threats and predict their threat types, thereby avoiding training the LLM with private or similarly sensitive data.

As already described, aspects of the technology herein rely on AI tools and, more particularly, certain types of generative machine learning models, such as large language models (LLMs) and generative adversarial networks (GANs).

A large language model (LLM) is an AI tool that generates language and performs other natural language processing tasks. An LLM can be trained in a self-supervised or semi-supervised manner by learning statistical relationships derived from large amounts of text (e.g., text available on the Internet).

An LLM is an artificial neural network. Some LLMs are built with a decoder-only transformer-based architecture that allows the LLM to process and generate text data at scale. Some LLMs can be adjusted to handle specific types of tasks and/or otherwise can be guided based on the construction of a prompt provided as input to the LLM.

LLMs are designed to understand the context of text data. They can analyze transaction data, customer complaints, social media posts, etc., and identify patterns that may indicate, e.g., card skimming activity. Other AI methods, on the other hand, often struggle with understanding context, especially when the data is unstructured.

LLMs are particularly dept at handling unstructured data, such as text from customer complaints or social media posts. They can extract meaningful insights from this data, which can be used to threats associated with electronic financial services.

In addition, LLMs can leverage transfer learning, where a model trained on one task is used as a starting point for a model on a second task. This means that an LLM trained on a large corpus of text data can be fine-tuned with a smaller amount of one or more specific types of data, such as data related to ATM transactions or customer complaints. This can lead to better performance with less data compared to other AI methods, which often require a large amount of task-specific data.

Another type of AI tool is a generative adversarial network (GAN). In a GAN, two neural networks—a generator and a discriminator—are pitted against each other in a zero-sum game, where one network's gain is the other's loss. This game allows the GAN to learn to generate new data with the same statistics as the training set. For example, a GAN trained on images can generate synthetic images that appear authentic.

The generator generates candidate outputs for the discriminator to evaluate. The generator's goal is to increase the error rate of the discriminator, e.g., to convince the discriminator that candidate outputs are authentic when in fact they are synthetic. In this manner, the GAN can learn to generate highly tuned synthetic data that mimics with high accuracy authentic data of the same type.

A known dataset serves as the initial training data for the discriminator. Training involves presenting it with samples from the training dataset until it achieves acceptable accuracy. The generator is trained based on whether it succeeds in fooling the discriminator. Typically, the generator is seeded with randomized input that is sampled from a predefined latent space (e.g., a multivariate normal distribution). Thereafter, candidates synthesized by the generator are evaluated by the discriminator. Independent backpropagation procedures are applied to both networks so that the generator produces better samples, while the discriminator becomes more skilled at flagging synthetic samples. When used for image generation, the generator is typically a deconvolutional neural network, and the discriminator is a convolutional neural network.

### System Overview

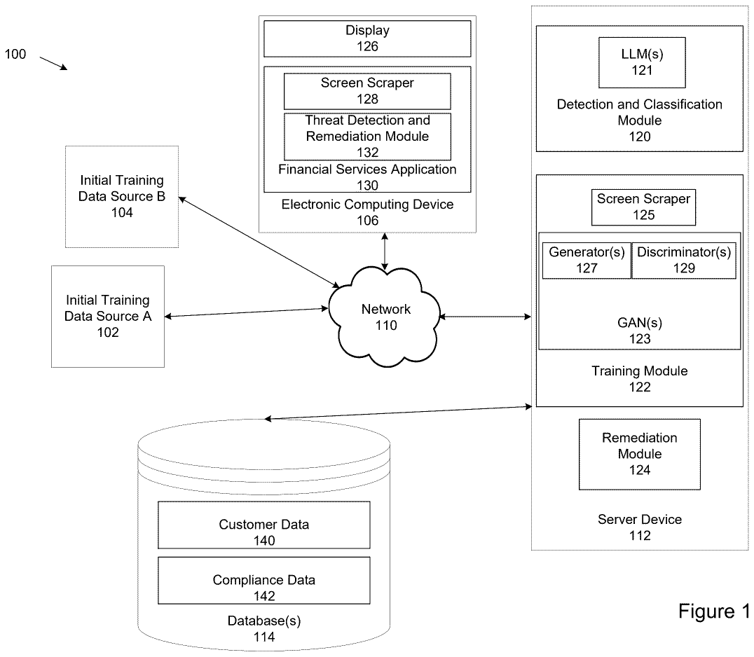

FIG. 1 schematically shows aspects of one example system 100 programmed to detect and manage threats associated with electronically-provided financial services.

In this example, the system 100 can be a computing environment that includes a plurality of electronic devices. In this instance, the system 100 includes an initial training data source A 102, an initial training data source B, an electronic computing device 106, a server device 112, and one or more databases 114. Each of the electronic devices, 102, 104 and 106 can communicate with the server device 112 through a network 110 to accomplish the functionality described herein.

Each of the electronic devices may be implemented as one or more computing devices with at least one processor and memory. Example computing devices include a mobile computer, a desktop computer, a server computer, or other computing device or devices such as a server farm or cloud computing used to generate or receive data.

In some non-limiting examples, the server device 112 is owned by a financial institution, such as a bank.

The electronic computing device 106 can be owned and/or operated by a customer of the financial institution. For example, the electronic computing device 106 can be a smartwatch, a smartphone, a tablet, or a laptop computer owned by a customer of the financial institution. In other examples, the electronic computing device 106 can be a device that is internal to the financial institution, such as a device on which a stakeholder of the financial institution creates and develops new products and services for the financial institution. In still other examples, the electronic computing device can be a piece of specialized hardware owned and/or operated by the financial institution, such as an ATM. Other configurations are possible.

The electronic computing device 106 can have installed thereon a financial services application 130 that generates user interfaces on the display 126 of the computing device 106. In the case of a customer or other non-internal user, the user interfaces can be interacted with to perform various financial transactions. In the case of an internal stakeholder, the interfaces can be used to create and develop financial services and products.

The financial services application 130 can include a screen scraper 128, e.g., as a plug-in software module to the standard financial services application. Functions of the financial services application 130 can communicate with the screen scraper 128 via an API. The screen scraper 128 is configured to capture screenshots as image files of user interfaces displayed on the display 126. For example, the screen scraper 128 can be configured to capture a screenshot every time the user interface displayed on the display 126 changes. The screen scraper 128 can be configured to save the screenshots with associated metadata, such as a timestamp linked to the image file indicating when the screenshot was captured. These image files and metadata can be provided to the threat detection and remediation module 132.

The threat detection and remediation module 132 can be configured as a plug-in software module to the standard financial services application. Functions of the financial services application 130 can communicate with the threat detection and remediation module 132 via an API. There can be separate APIs for each of the screen scraper 128 and the threat detection and remediation module 132. Alternatively, the screen scraper 128 can be built as a component of the threat detection and remediation module 132.

The screen scraper 128 and threat detection and remediation module 132 are configured to operate in parallel with electronic financial services process flows of the financial services application 130. That is, the screen scraper 128 and threat detection and remediation module 132 are configured to operate in the background, without interrupting the user-facing functionality of the financial services themselves and at the same time intercepting data generated by that functionality.

The threat detection and remediation module 132 is configured to capture types of data that can be used by the server device 112 to determine if there is a threat associated with some operation being performed by the electronic computing device 106, such as a requested transaction requested via electronic computing device 106, or a new product or service that is being built using the electronic computing device 106.

The threat detection and remediation module 132 collects data that is potentially relevant to one or more threats and provides that data, via the network 110, to the server device 112. Such data can include, for example the screenshots described above and captured by the screen scraper 128, data from voice input captured by a microphone on or near the electronic computing device 106, data from image input captured by a camera on or near the electronic computing device 106, data about the performance and or failures of the underlying financial services application 130, data indicating how long transactions are taking to complete, data indicating how frequently transactions are being performed via the electronic computing device 106, data indicating the amount of processing power being consumed to operate the financial services application 130, and the like.

The system 100 can include any number of initial training data sources. For illustrative purposes, two such data sources are shown. Each initial training data source 102, 104 is a source of initial training data for the training module 122 of the server device 112. The electronic devices corresponding to the initial training data sources provide data that allows the training module 122 to learn how to detect a threat associated with an electronic financial service versus a non-threat and, if a threat is detected, how to classify the threat and identify the type of threat. The initial training data sources 102 and 104 can be operated internally by the financial institution or externally. The initial training data that is provided can be data that is publicly available (e.g., via the Internet), or limited to authorized access only.

Non-limiting examples of the types of initial training data that can be obtained by the server device 112 from initial training data sources such as the initial training data sources 102 and 104 can include: physical security logs, previous data compromises and remediation, firewall logs, issues in which wrong credentials were used and the remediations, wrong software patches being used, internal procedures that have gone wrong and the remediations, internal systems that were not updated or upgraded, malwares and/or ransomware detectors that were not updated, policy adherence compliance and/or regulations, port scanning logs and remediations for issues involving port scanning, vendor access logs and remediations for issues involving vendor access, wrong web portals, data loss prevention issues and policies, previous sensitive, private or confidential data incidents and how those incidents were remediated, code patches, vulnerable jars, vulnerable jar identification procedures, patching logs, maintenance windows, standard operating procedures, user manuals, denial of service (DOS) attack incidents, money laundering transactional behavior patterns, money laundering incidents, network logs, application level logs, device logs, threat incidents encountered by other financial institution, previous infrastructure incidents such as high resource usages or hardware going down, previous ATM issues, such as incidents of ATM skimming, and the like.

The example server device 112 is programmed to, e.g., execute or at least facilitate execution of financial transactions initiated at another electronic device (such as the electronic computing device 106), generate electronic financial services, detect threats associated with electronically-provided financial services facilitate financial transactions, classify the threats, and perform automated actions in response to detected and classified threats based on the threat type and/or other classification attributes.

The example database 114 of the system 100 is programmed to store data that can be used by the server device 112 to perform its various functionalities. For example, the database can store customer data 140 and compliance data 142.

The customer data 140 can be used by the server device 112 to, e.g., establish patterns of transactional behavior over time for a given customer from which the server device 112 can determine the workings of a pattern of behavior that may indicate a threat. For example, the customer data 140 can include information about a customer's series of transactions, where the type, number and frequency of those transactions, transaction amounts, and the like could be indicative of money laundering.

The compliance data 142 can include documents and other files with text of the financial institution's internal process policies and external regulations that must be followed by the financial institution when providing products and services.

In some examples, the database 114 is a relational database, an objected-oriented database, a hierarchical database, and/or a cloud database. Many other configurations are possible.

The network 110 provides a wired and/or wireless connection between the initial training data source A 102, the initial training data source B 104, the electronic computing device 106 and the server device 112. In some examples, the network 110 can be a local area network, a wide area network, the Internet, a near field communication (NFC) network, or a mixture thereof. Many different communication protocols can be used. Although only four device (other than the database 114) are shown, the system 100 can accommodate hundreds, thousands, or more of computing devices.

The server device 112 includes software modules for performing functionalities of the system 100 described herein.

For example, the server device 112 can include a detection and classification module 120, a training module 122, and a remediation module 124. The detection and classification module 120 can include one or more LLMs 121. The training module 122 can include a screen scraper 125 and one or more GANs 123. Each GAN can include a generator 127 and a discriminator 129. It will be appreciated that one or more of these modules or one or more components thereof can be stored in non-transitory computer readable storage that is remote from the server device 112 (e.g., within a cloud) but that the server device 112 accesses via the network 110 to perform the functionalities described herein.

In operation, the training module 122 receives initial training data from the initial training data sources, such as the initial training data source A 102 and the initial training data source B 104. In some examples, initial training data can also be obtained from the database 114, such as the compliance data 142.

The initial training data can be in the form of voice data (e.g., captured by a microphone from utterances of a customer or bad actor near the electronic computing device 106 and containing transaction data or motive data), image data (e.g., from a security camera or from a captured screen shot of a display showing transaction information), text data and the like.

The initial training data is used to train the GAN 123 and/or the LLM 121. For example, the discriminator 129 initially learns how to detect and classify threats based on the initial training data. The generator 127 then generates synthetic data based on the initial training data and the discriminator 129 learns to identify the data as synthetic or authentic, improving the generator's ability to generate synthetic data that appears authentic. Once the discriminator 129 has fine-tuned the generator 127, the generator 127 is now configured to generate high quality synthetic threat data that is used to train the LLM 121. By generating and using high quality synthetic threat data, privacy and confidentiality issues associated with internal use or customer use of financial services can be avoided.

For example, the generator 127 learns to generate synthetic screen shots that indicate a money laundering threat and synthetic video footage that indicates an ATM skimming attack. As another example, the generator 127 learns to generate a new financial service (e.g., a new credit card with new credit card terms) that indicates a threat of a violation of an internal policy or a regulation.

In some examples, the LLM 121 is trained from the initial training data directly, without the GAN 123 first generating synthetic training data.

The synthetic data can include both the synthetic action data as well as whether that action data indicates a threat and if so, the type of threat. The synthetic data is fed to the LLM 121 to train the LLM to detect threats from new action data and to classify those threats into different classifications.

New action data can be any of the types if initial training data described above, and/or other types of data that are fed to the trained LLM 121 and from which the trained LLM 121 predicts a threat and a classification of that threat. New action data can include text data, image data, audio data, metadata (e.g., screen shot meta data, voice data metadata, image data metadata) and the like. New action data can be captured by the electronic computing device 106 and by the screen scraper 125 operating from the server device 112 and capturing screen shots from electronic devices remote from the server device 112.

A given classification can be defined by one or more attributes of the threat, such as, but not limited to, the type of threat (e.g., money laundering, compliance failure, malware attack, phishing attack, denial of service attack, SQL injection, and the like), the severity of the threat (e.g., low severity, medium severity, high severity), the source of the threat (e.g., internal to the financial institution, external to the financial institution (customer or bad actor), the magnitude of the potential impact of the threat (e.g., low impact, medium impact, high impact), and the availability of the threat (e.g., a real time current threat, a near future threat, or a past threat).

Using the trained LLM 121, the detection and classification module 120 is configured to evaluate new action data to predict whether the new action data is indicative of a threat and if so, to classify that threat according to classification attributes, such as those described above.

The new action data can be generated by the electronic computing device 106. In some examples, the new action data is captured by the threat detection and remediation module 132, as described above, and fed to the LLM 121.

The LLM is also trained (via the mechanisms described herein) to predict that new action data is part of a pattern of data corresponding to a threat, and flag the new action data as such, linking the new action data to other prior action data that develops the pattern. The other prior action data can be obtained, e.g., from the customer data 140. For instance, the other prior action data can include information about various prior transactions executed by a given customer which help to establish, together with the new action data, a pattern indicative of a threat that the LLM 121 then classifies. Eventually, as more new transaction data is captured, the pattern is either confirmed by the LLM 121 or never established and eventually dropped.

While the pattern is being built and before a final threat decision regarding the pattern is determined, the LLM can cause the pattern data to be stored, e.g., in the database 114 that can later be accessed by the LLM 121 when new action data is received that relates to the pattern (e.g., the new action data includes the same customer identifier or account number as that of the pattern).

Over time, the new action data provides reinforcement learning to the trained LLM 121, effectively improving the LLM 121's ability to accurately discern and classify threats.

Once a threat has been detected and classified by the LLM, in some examples, the remediation module 124, based on the attributes of the classification, automatically causes a remedial action tailored to the classification to be performed. The remedial action can include generating a report that details the threat, how it arose, the attributes of its classification, and the likelihood that it is real. The remedial action can include disabling a computing device (e.g., disabling an ATM) or a software function (e.g., money transfers) of a software application. The remedial action can include generating a message with a recommendation to update a piece of software, install a software patch, replace a piece of hardware, and the like. The remedial action can include generating an alert that is sent to a computing device of a security team. The remedial action can include generating a message warning that a proposed new product or service would violate a particular regulation or internal policy. Many other remediations generated by the remediation module 124 are possible.

In some examples, depending on the remediation determined by the remediation module 124, an aspect of the remediation can be performed by the threat detection and remediation module 132 on the electronic computing device 106 that is remote from the server device 112. For example, if the remediation includes disabling an application function at the electronic computing device 106, that remediation can be performed by the threat detection and remediation module 132 based on signals generated by the remediation module 124 and transmitted by the server device 112.

The type of threat detected and classified by the LLM 121 can be a vulnerability as opposed to an illegal or wrong action, e.g., a vulnerability in a piece of hardware or software. In these examples, the LLM can be trained to generate a prediction that a security breach or other form of illegal or bad action is likely to occur within a defined period of time as a result of the vulnerability, and the remediation module 124 generates a message with a recommendation for how and by when to shore up the vulnerability.

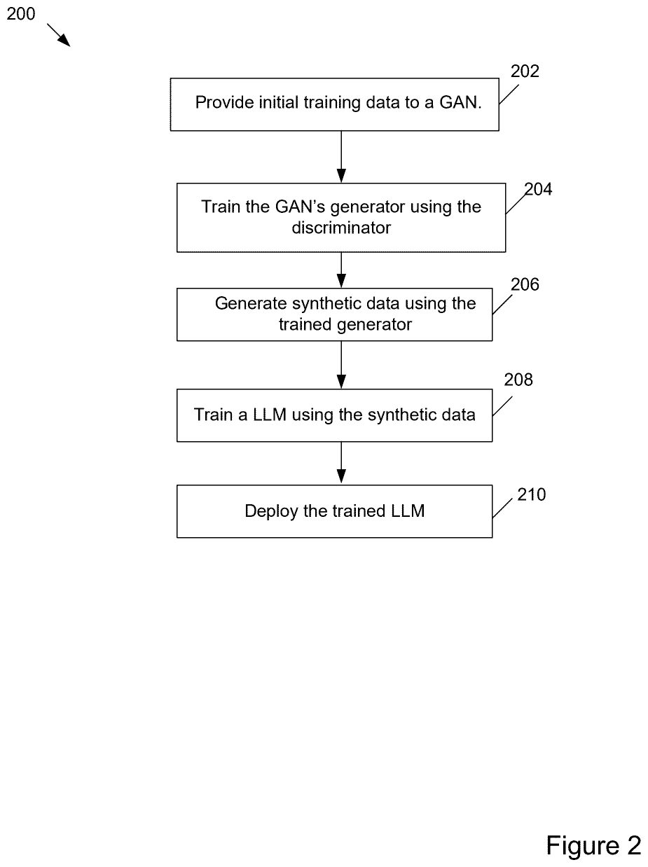

FIG. 2 shows an example method 200 that can be performed using the system of FIG. 1.

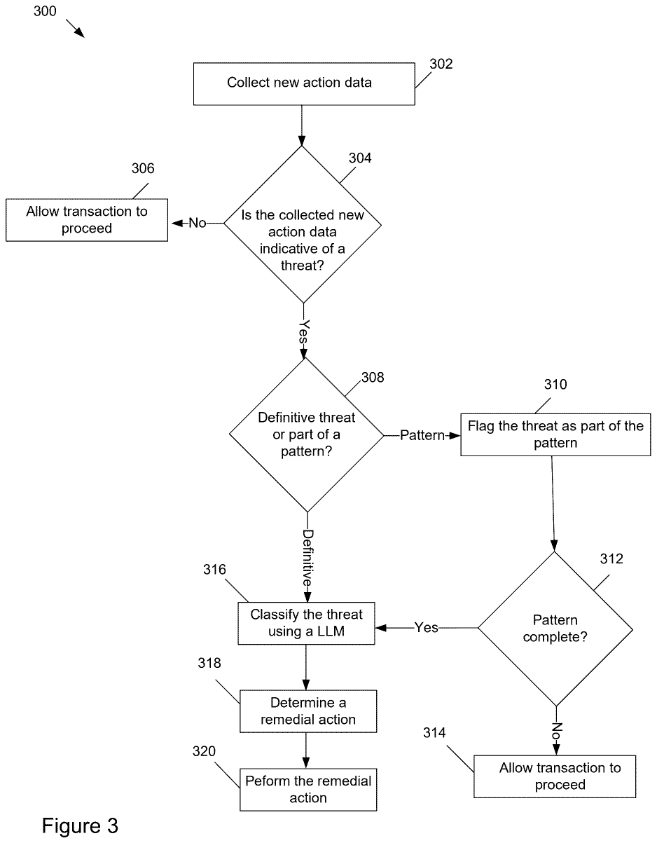

FIG. 3 shows another example method 300 that can be performed using the system of FIG. 1.

Methods of the present disclosure can include more or fewer steps than the enumerated steps of method 200 and/or the method 300. Methods of the present disclosure can include steps of the method 200 and/or 300 performed in a different order than depicted. In some examples, at least some of the steps of the method 200 and/or 300 are performed by the server device 112. In some examples, some of the steps of the method 200 and/or 300 are performed by one or more other devices of the system 100. In some examples, methods of the present disclosure include at least some steps from each of the methods 200 and 300.

Referring to FIG. 2, at a step 202 of the method 200, initial training data relating to threats to electronically-provided financial services is collected and provided to a GAN.

At a step 204 of the method 200, the GAN's generator is trained to generate highly tuned synthetic data using the discriminator.

At a step 206 of the method 200, the trained generator generates synthetic data that can be used to train another machine learning model.

At a step 208 of the method 200, a LLM is trained using the synthetic data generated at the step 206.

At a step 210 of the method 208, the trained LLM is deployed to, e.g., receive new action data and predict and classify threats indicated by the new action data.

Referring to FIG. 3, the method 300 can occur once the LLM is trained according to the method 200 of FIG. 2.

At a step 302 of the method 300, new action data is collected. The new action data can include data about newly initiated transactions, new financial services or products that are being developed, and the like.

At a step 304 of the method 300, it is determined (e.g., by a trained LLM) whether the collected new action data is indicative of a threat.

If at the step 304 it is determined that the collected new action data is not indicative of a threat, then the method 300 advances to the step 306 at which the transaction is allowed to proceed and no further threat related action is initiated.

If at the step 304 it is determined that the collected new action is indicative of a threat, then the method advances to the step 308 at which it is determined whether the detected threat is a definitive threat or merely part of a pattern that could later indicate a threat based on more new action data obtained later.

If at the step 308 it is determined that the detected threat is merely part of a pattern, then the method 300 advances to the step 310 at which the threat is flagged as part of an existing pattern.

From the step 310 the method 300 advances to the step 312 at which it is determined whether the pattern is a complete pattern of a threat or still an incomplete pattern of a threat.

If at the step 312 it is determined that the pattern is still incomplete (e.g., more data is needed to confirm the pattern as a definitive threat), then the method 300 advances to the step 314 at which the transaction is allowed to proceed and no further threat related action is initiated.

If at the step 312 it is determined that the pattern is complete, then the method 300 advances to the step 316 at which the trained LLM classifies the definitive threat represented by the pattern.

From the step 316 the method 300 then advances to the step 318 at which a remedial action to address the definitive threat embodied by the complete pattern is determined. The type of remedial action can be determined based on one or more classification attributes of the definitive threat as classified by the trained LLM at the step 316.

From the step 318, the method proceeds to the step 320 at which the determined remedial action is performed.

If at the step 308 it is determined that the detected threat is definitive, then the method 300 advances to the steps 316, 318 and 320 as just described.

### Example Implementations

Non-limiting example implementations of the system 100 of FIG. 1 will now be described.

In an example regulatory compliance implementation, a batch job to remove or archive database-stored documents that are outdated is initiated.

The threat detection and remediation module 132 intercepts the initiated batch job request. In this example, the threat detection and remediation module 132 can be located in a document service layer of the financial institution's computing environment. The intercepted request is fed to the trained LLM 121.

Having been trained on initial training data (and, in some examples, synthetic GAN generated data) that includes rules and policies relates to document deletion and archiving under various conditions, the trained LLM 121 determines whether the batch job request potentially violates any rules or regulations.

If the trained LLM 121 predicts a definitive threat and classifies the threat as a violation of the rules or policies has occurred or will occur, the remediation module 124 generates signals that are transmitted to the threat detection and remediation module 132 tailored to the threat classification. The threat detection and remediation module 132 then either prevents the requested deletion or archiving, and/or generates an alert that is provided to a security team via an electronic device.

In an example anti-money laundering implementation, a customer logs into their bank account on the electronic computing device 106 via the financial services application 130. Within the financial institution's computing environment, a backend transaction service layer is triggered to perform the requested transaction.

The threat detection and remediation module 132 intercepts the request and sends data (e.g., a captured screenshot of the display 126) to the trained LLM 121 at the backend.

Having been trained on initial training data (and, in some examples, synthetic GAN generated data) that includes transactional rules and policies, money laundering transaction patterns, and the like, the trained LLM 121 predicts whether the request is for the purpose of money laundering.

If the trained LLM 121 predicts a definitive threat and classifies the threat as a transaction request for money laundering purposes, the remediation module 124 generates signals that are transmitted to the threat detection and remediation module 132. The threat detection and remediation module 132 then either prevents the requested transaction and/or generates an alert that is provided to a security team via an electronic device.

In an example ATM skimming implementation, the LLM 121 is trained to analyze transaction data and identify patterns that may indicate skimming activity. For example, a sudden increase in transactions at a particular electronic computing device 106 which, for purposes of this example is an ATM, or a series of transactions at the ATM 106 where the entered PIN was incorrect could be signs of skimming. Such training data and new action data can be intercepted by a threat detection and remediation module 132 located on the ATM 106. In some cases, the screen scraper 128 captures screenshots from the ATM's display from which transaction data is obtained. The threat detection and remediation module 132 can also capture threat-related data from security cameras and microphones located near the ATM 106.

The LLM 121 can also be trained to analyze text data, such as customer complaints or social media posts, to identify potential skimming activity. For example, multiple complaints about a specific ATM could indicate a skimmer is present.

In addition, the LLM 121 can be trained to predict which ATMs are most likely to be targeted by skimmers. This could be based on factors such as transaction metadata, e.g., the location of the ATM 106 and the transaction volume, as well as other data such as number and frequency of previous skimming incidents at the ATM 106.

Once potential skimming activity at a given ATM 106 is identified by the trained LLM 121 as a definitive threat, appropriate actions tailored to the threat classification and performed by the remediation module 124 and the threat detection and remediation module 132 located in the ATM 106 can then take place to disable the skimmer, such as disabling the card reader of the ATM 106 or automatically alerting law enforcement.

### Computing Architecture

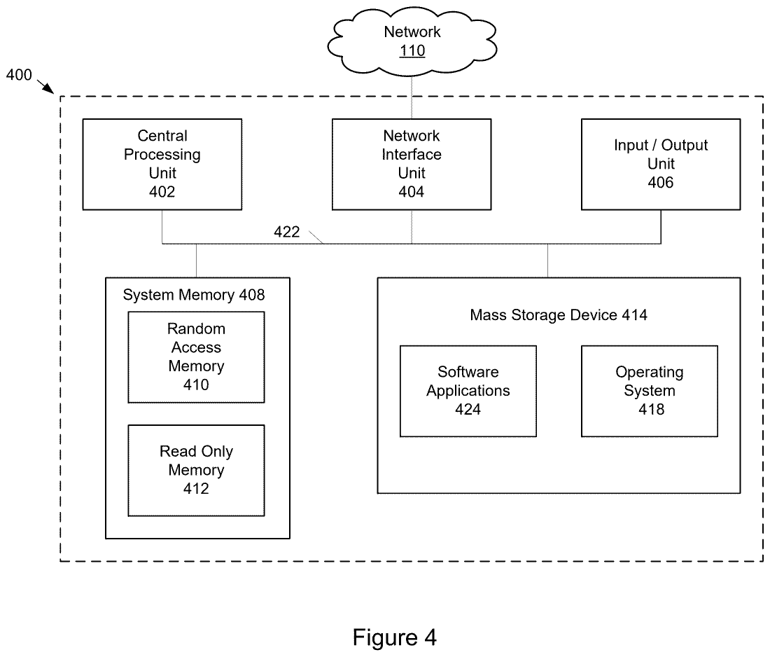

Additional components of the system 100 of FIG. 1 are illustrated in FIG. 4.

The electronic computing device 400 can correspond to any of the server device 112, the initial training data source A 102, the initial training data source B 104, or the electronic computing device 106 of FIG. 1. Components of the computing device 400 can correspond to other components of the system 100 of FIG. 1, such as the database(s) 114.

When the computing device 400 corresponds to the server device 112, the computing device 400 can be an internally controlled and managed device (or multiple devices) of an enterprise, e.g., a financial institution that offers various banking services to its customers. Alternatively, the computing device 400 can represent one or more devices operating in a shared computing system external to the enterprise, such as a cloud.

As illustrated in the embodiment of FIG. 4, the example computing device 400, which provides the functionality described herein, can include at least one central processing unit (“CPU”) 402, a system memory 408, and a system bus 422 that couples the system memory 408 to the CPU 402. The system memory 408 includes a random access memory (“RAM”) 410 and a read-only memory (“ROM”) 412. A basic input/output system containing the basic routines that help transfer information between elements within the computing device 400, such as during startup, is stored in the ROM 412. The computing device 400 further includes a mass storage device 414. The mass storage device 414 can store software instructions and data. A central processing unit, system memory, and mass storage device similar to that shown can also be included in the other computing devices disclosed herein.

The mass storage device 414 is connected to the CPU 402 through a mass storage controller (not shown) connected to the system bus 422. The mass storage device 414 and its associated computer-readable data storage media provide non-volatile, non-transitory storage for the computing device 400. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing device 400.

According to various embodiments of the invention, the computing device 400 may operate in a networked environment using logical connections to remote network devices through network 110, such as a wireless network, the Internet, an NFC network, or another type of network, or combination of networks. The computing device 400 may connect to a network 110 through a network interface unit 404 connected to the system bus 422. It should be appreciated that the network interface unit 404 may also be utilized to connect to other types of networks and remote computing systems. The computing device 400 also includes an input/output controller 406 for receiving and processing input from a number of other devices, including a touch user interface display screen or another type of input device (e.g., the display 126 of FIG. 1). Similarly, the input/output controller 406 may provide output to a touch user interface display screen or other output devices.

As mentioned briefly above, the mass storage device 414 and the RAM 410 of the computing device 400 can store software instructions and data. The software instructions include an operating system 418 suitable for controlling the operation of the computing devices of the system 100. The mass storage device 414 and/or the RAM 410 also store software instructions and applications 424, that when executed by the CPU 402, cause the computing device 400 to provide the functionality of the various devices of the system 100 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A method of managing threats to electronically-provided financial services, comprising:
providing initial training data to a discriminator of a generative adversarial network (GAN), the initial training data being generated from a misuse of an electronically-provided financial service;
training the discriminator using a generator of the GAN to provide a trained GAN;
generating synthetic data using the trained GAN; and
training a large language model (LLM) using the synthetic data to provide a trained LLM.

2. The method of claim 1, further comprising using the trained LLM to detect and classify with a classification a new threat to the electronically-provided financial service to provide a classified new threat.

3. The method of claim 2, wherein classifying the new threat by the trained LLM is performed based on new transaction data provided to the trained LLM.

4. The method of claim 2, further comprising:
classifying the new threat by the trained LLM based on new data collected from a plurality of new transactions, the new data being provided to the trained LLM; and
detecting a threat pattern in the new data.

5. The method of claim 2, further comprising generating a response to the classified new threat based on the classification.

6. The method of claim 5, wherein the response includes generating signals and transmitting the signals to a machine that provides electronic financial services, causing the machine to disable one or more of the electronic financial services.

7. The method of claim 6, wherein the machine is an automated teller machine (ATM).

8. The method of claim 5, wherein the response includes generating signals and transmitting the signals to a computing device causing the computing device to generate an alert that a threat has been detected for one of the electronically-provided financial services, the alert identifying a type of the threat.

9. The method of claim 8, wherein the type of the threat is one of: a data breach, an insider threat, a system downtime, a hardware malfunction, a physical security system malfunction, a computing device running outdated software, an accessing or sharing of sensitive customer data, skimming of an automated teller machine (ATM), an ATM cash out attack, a malware attack, a ransomware attack, a phishing attach, a social engineering attack, a distributed denial of service (DDoS) attack, non-compliance with a policy or regulation, high resource usage, a zero-day exploit, a vulnerable file being used to package an application, a fraudulent transaction, money laundering, a SQL injection, an ATM card withdrawal limit change, a card approval process change, greater than a predefined number of instances of a failures for the application or an application programming interface (API) of the application within a predefined period of time, greater than a predefined length of time for responses generated by the application, and greater than a predefined number of database query failures with another predefined length of time.

10. The method of claim 1, further comprising:
using a screen scraper to capture screenshots of a display of an electronic computing device,
wherein the initial training data includes the screenshots.

11. A system for managing threats to electronically-provided financial services, comprising:
an electronic computing device, including:
a financial services application installed on the electronic computing device and configured to initiate a transaction; and
a threat detection module installed on the electronic computing device and configured as a plug-in to the financial services application, the threat detection module being configured to collect data associated with the transaction to provide collected data; and
a server, including:
one or more processors; and
non-transitory computer-readable storage media encoding instructions which, when executed by the one or more processors, causes the system to:
receive transaction data generated by the financial services application;
receive the collected data;
determine whether the collected data is indicative of a threat to an electronically-provided financial service;
when the collected data is not indicative of the threat, allow the transaction to proceed;
when the collected data is indicative of the threat:
classify the threat using a large language model (LLM) to provide a classified threat;
determine a remedial action based on a type of the classified threat; and
perform the remedial action to address the threat based on the type.

12. The system of claim 11, wherein the remedial action includes preventing the transaction from proceeding.

13. The system of claim 11, wherein the remedial action includes to:
flag the collected data as relating to a data pattern associated with the classified threat to provide flagged data; and
link the flagged data to other data of the data pattern.

14. The system of claim 13, wherein the non-transitory computer-readable storage media encodes further instructions which, when executed by the one or more processors, causes the system to:
receive subsequent collected data associated with a subsequent transaction;
determine that the subsequent collected data relates to the data pattern to provide an augmented data pattern; and
based on the augmented data pattern, generate signals and transmit the signals to a computing device causing the computing device to generate an alert identifying the type of the threat that has been detected.

15. The system of claim 14, wherein the non-transitory computer-readable storage media encodes further instructions which, when executed by the one or more processors, causes the system to, based on the augmented data pattern, prevent the subsequent transaction from proceeding.

16. The system of claim 14, wherein the type of the threat is one of: a data breach, an insider threat, a system downtime, a hardware malfunction, a physical security system malfunction, a computing device running outdated software, an accessing or sharing of sensitive customer data, skimming of an automated teller machine (ATM), an ATM cash out attack, a malware attack, a ransomware attack, a phishing attach, a social engineering attack, a distributed denial of service (DDoS) attack, non-compliance with a policy or regulation, high resource usage, a zero-day exploit a vulnerable file being used to package an application, a fraudulent transaction, money laundering, a SQL injection, an ATM card withdrawal limit change, a card approval process change, greater than a predefined number of instances of a failures for the application or an application programming interface (API) of the application within a predefined period of time, greater than a predefined length of time for responses generated by the application, and greater than a predefined number of database query failures with another predefined length of time.

17. The system of claim 11, wherein the electronic computing device is included in an automated teller machine (ATM).

18. The system of claim 11,
wherein the electronic computing device includes a display;
wherein the threat detection module encodes a screen scraper; and
wherein the collected data is based on a screenshot of the display captured by the screen scraper.

19. The system of claim 18, wherein the electronic computing device is included in an automated teller machine (ATM).

20. A system for managing threats to electronically-provided financial services, comprising:
one or more processors; and
non-transitory computer-readable storage media encoding instructions which, when executed by the one or more processors, causes the system to:
receive initial training data in a discriminator of a generative adversarial network (GAN), the initial training data being generated from a misuse of an electronically-provided financial service and including a screenshot captured by a screen scraper installed on an electronic computing device;
training the discriminator using a generator of the GAN to provide a trained GAN;
generate synthetic data using the trained GAN;
train a large language model (LLM) using the synthetic data to provide a trained LLM;
receive transaction data generated by a financial services application installed on another electronic computing device;
receive, by the trained LLM, collected data collected by a threat detection module installed as a plug-in to the financial services application;
classify, by the trained LLM and based on the collected data, a threat to provide a classified threat; and
perform a remedial action to address the classified threat based on a type of the classified threat.
